(19) United States
(12) Patent Application Publication
(10) Pub. No.: US 2025/0070866 A1
(43) Pub. Date: Feb. 27, 2025

(54) WIRELESS COMMUNICATION SYSTEMS WITH LONG-RANGE, INFRASTRUCTURE-FREE NETWORKING CAPABILITY

(71) Applicant: Lynq Technologies, Inc., Boulder, CO (US)

(72) Inventors: Michael Wrape, Temescal Valley, CA (US); Adam Gould, Poway, CA (US); Jonathan E. Horne, Boulder, CO (US); John Peter Norair, Jersey City, NJ (US)

(21) Appl. No.: 18/238,188

(22) Filed: Aug. 25, 2023

(51) Int. Cl. H04B 7/26

(52) U.S. Cl. CPC H04B 7/2643; H04W 84/18; H04W 92/18

(57) ABSTRACT

Methods, systems, and processor-readable storage media for implementing wireless communication systems with low power, long-range, infrastructure-free networking capability are provided herein. An example wireless communication system includes: at least one radio transceiver unit configured to facilitate communication, directly between two or more user devices, up to and exceeding an intended range, wherein facilitating communication includes tuning, during communication between the user devices, at least one RF band, at least one transmitter MCS, transmitter output power associated the user devices, and/or one or more coding techniques; and at least one network execution unit configured to perform one or more network-related functions related to establishing and/or maintaining at least one wireless network, among the user devices, that is infrastructure-free and self-forming in nature, wherein performing includes facilitating network-related participation from each user device and carrying out one or more network synchronization functions during communication between the user devices.

### FIELD

The field relates generally to information technology, and more particularly to network-related technologies.

### BACKGROUND

Conventional headsets and other similar devices with two-way communication capabilities used in applications across numerous industry sectors (e.g., public safety, commercial aviation, military and/or defense, heavy industry with noisy environments, etc.) often rely on physical cables connected to expensive and bulky portable radios or to vehicle intercom systems. Accordingly, such conventional headsets are constrained at least by the length of the cables, limiting transmission ranges and precluding use cases related thereto.

Similarly, other conventional approaches which attempt to implement wireless headsets typically rely on very short range wireless technologies such as, for example, Bluetooth or longer range technologies such as, e.g., Digital Enhanced Cordless Telecommunications (DECT), but which require a fixed terminal base station node in a star network topology to coordinate all communications. However, such conventional approaches are all constrained by some combination of limited transmission range, support for a small number of headset users, or dependence upon some form of network infrastructure for network control, which negatively impacts performance (e.g., increased latency), reduces flexibility, and often increases costs.

### SUMMARY

Illustrative embodiments of the invention provide wireless headsets with long-range, infrastructure-free networking capability. An example wireless communication system includes at least one radio transceiver unit configured to facilitate communication, directly between two or more user devices, up to and exceeding an intended range, wherein facilitating the communication includes tuning, during communication directly between at least a portion of the two or more user devices, one or more of at least one radio frequency (RF) band, at least one transmitter modulation and coding scheme (MCS), transmitter output power associated with at least one of the two or more user devices, and one or more coding techniques. The example wireless communication system also includes at least one network execution unit configured to perform one or more network-related functions related to at least one of establishing and maintaining at least one wireless network, among the two or more user devices, that is infrastructure-free and self-forming in nature, wherein performing one or more network-related functions includes facilitating network-related participation from each of the two or more user devices and carrying out one or more network synchronization functions during communication directly between at least a portion of the two or more user devices.

An example computer-implemented method includes facilitating communication directly between two or more user devices, up to and exceeding an intended range, wherein facilitating the communication includes tuning, during communication directly between at least a portion of the two or more user devices, one or more of at least one RF band, at least one transmitter MCS, transmitter output power associated with at least one of the two or more user devices, and one or more coding techniques. The method also includes performing one or more network-related functions related to at least one of establishing and maintaining at least one wireless network, among the two or more user devices, that is infrastructure-free and self-forming in nature, wherein performing one or more network-related functions includes facilitating network-related participation from each of the two or more user devices and carrying out one or more network synchronization functions during communication directly between at least a portion of the two or more user devices.

Additionally, an example headset apparatus includes at least one microphone element and at least one speaker element. The example headset apparatus also includes at least one radio transceiver unit configured to facilitate communication, directly between the headset apparatus and one or more user devices, up to and exceeding an intended range, wherein facilitating the communication includes tuning, during communication directly between the headset apparatus and at least a portion of the one or more user devices, one or more of at least one RF band, at least one transmitter MCS, transmitter output power associated with at least one of the headset apparatus and the one or more user devices, and one or more coding techniques. Further, the example headset apparatus also includes at least one network execution unit configured to perform one or more network-related functions related to at least one of establishing and maintaining at least one wireless network, among the headset apparatus and the one or more user devices, that is infrastructure-free and self-forming in nature, wherein performing one or more network-related functions includes facilitating network-related participation from each of the headset apparatus and the one or more user devices and carrying out one or more network synchronization functions during communication directly between the headset apparatus and at least a portion of the one or more user devices.

Illustrative embodiments can provide significant advantages relative to conventional headset approaches. For example, challenges associated with limited transmission ranges and dependencies on centrally controlled networks are overcome through implementing wireless headsets with long-range, infrastructure-free networking capability.

These and other illustrative embodiments described herein include, without limitation, methods, apparatus, networks, systems and processor-readable storage media.

### BRIEF DESCRIPTION OF THE DRAWINGS

FIG. 1 is a block diagram of a network configured for wireless communication systems with low power, long-range, infrastructure-free networking capability in an example embodiment of the invention;

FIG. 2 is a diagram illustrating a wireless headset network system in an example embodiment of the invention;

FIG. 3 is a diagram illustrating a private person-to-person communication mode within a wireless network in an example embodiment of the invention;

FIG. 4 is a diagram illustrating a group communication mode within a wireless network in an example embodiment of the invention;

FIG. 5 is a diagram illustrating a communication mode within a wireless network wherein all active users can participate in an example embodiment of the invention;

FIG. 6 is a diagram illustrating a wireless network system configured to operate as a mesh network in an example embodiment of the invention;

FIG. 7 is a diagram illustrating a block diagram of a wireless communication system in an example embodiment of the invention;

FIG. 8 is a diagram illustrating using a wireless headset network to act as a data network for sharing location information in an example embodiment of the invention;

FIG. 9 is a diagram illustrating location data sharing in connection with a gateway in an example embodiment of the invention; and

FIG. 10 is a flow diagram of a process for implementing wireless communication systems with low power, long-range, infrastructure-free networking capability in an example embodiment of the invention.

### DETAILED DESCRIPTION

As detailed herein, one or more embodiments of the invention include generating and/or implementing wireless communication systems with low power, long-range, infrastructure-free networking capability. As used herein, low power refers to an equivalent radiated power (ERP) of approximately one watt or less. Also, as used herein, a wireless network with infrastructure-free networking capability and/or a wireless network that is infrastructure-free in nature includes networks that are self-forming and have no radio access network infrastructure (that is, a network that does not need or rely on radio access network infrastructure such as, e.g., base stations, access points, controllers, arbitrators, etc.). Furthermore, as used herein, a self-forming network with no centralized network control infrastructure is distributed in nature, with nodes (e.g., devices) that are able (e.g., via a consensus-based algorithm) to orchestrate the formation of a network amongst themselves, decide how to allocate network resources (e.g., time and frequency), and/or control overall network communications, with all nodes (e.g., devices) equally capable in terms of the roles played in such controlling.

Accordingly, at least one embodiment includes creating and/or implementing wireless communication systems (e.g., wireless headsets) with two-way, group and broadcast communications capabilities that can readily form at least one network with two or more of the same or similarly equipped communication systems (e.g., wireless headsets).

By way merely of illustration and/or example, a wireless headset, as used herein, can include one or more speakers (e.g., two speakers), one or more microphones (e.g., one microphone), and one or more components (e.g., earcups) which contain at least a portion of the one or more speakers and/or at least one radio transceiver. An example wireless headset can also include at least one mechanical system for attaching at least portions of the one or more components together and enabling a user to wear the headset (e.g., with earcups over the user's ears and a microphone (e.g., configured in connection with a boom component) positioned and/or able to be positioned close to the user's mouth). Additionally, as noted above, an example wireless headset can include at least one radio transceiver which enables the wireless headset to communicate directly (e.g., over long-ranges) with one or more other devices (such as other wireless headsets). In one or more embodiments, such a radio transceiver contains infrastructure-free networking software which facilitates and/or enables the forming and managing of a wireless network among two or more wireless headsets, wherein each such wireless headset contains similar software and can form and/or manage the wireless network in conjunction with each of the other one or more wireless headsets.

Also, in such an embodiment the wireless headsets are configured with long-range transmission capabilities, and do not require association with any base stations and/or other fixed hardware (e.g., controllers) or infrastructure. By way of example, in one or more embodiments, long-range transmission capabilities can encompass a transmission range up to and exceeding at least approximately one kilometer between two or more devices without the use or need of centralized infrastructure or mesh network topologies (and absent, e.g., any external obstacles or blockages).

Further, as additionally described herein, one or more embodiments include configuring such wireless headsets to share and/or exchange non-voice data (e.g., simultaneously and/or approximately simultaneously with voice data) between headset devices, wherein such non-voice data can include, for example, Position Location Information (PLI), live video, still camera images, messaging information, related and/or corresponding user sensor reporting information, etc. Sources of such data can be related to one or more expanded capabilities of a wireless headset itself (e.g., the addition and/or incorporation of at least one global navigation satellite system (GNSS) receiver for PLI, at least one video camera, etc.), and/or the wireless headset can act as a hub for a collection of sensor information (derived, for example, from at least one body area network (BAN) for purposes of, e.g., sending such data over a low power, long-range, infrastructure-free wireless network to an operations center that is monitoring the actions and health of the user).

Accordingly, at least one embodiment includes equipping wireless headsets with an infrastructure-free network radio solution for the purposes, for example, of replacing cables and supporting low power, long-range, low-latency, and high quality voice data transmission for direct headset-to-headset multi-way communications without the need for associated network infrastructure.

As also detailed herein, one or more embodiments can be implemented in connection with one or more form factors. For example, in such an embodiment, at least one dongle apparatus is configured with the same or similar wireless infrastructure-free network radio capabilities and/or solution, wherein such a dongle can be connected via at least one headset audio cable or other attachment means to at least one legacy cabled headset for the purpose of adapting the legacy cabled headset to at least one wireless network and providing the legacy cabled headset with the same wireless communication capabilities as those described herein in connection with one or more embodiments. Additionally or alternatively, and in a similar fashion as that of legacy cabled headsets, short-range wireless legacy Bluetooth headsets, for example, can be connected over small distances (e.g., tens of feet) to a dongle which supports both short-range wireless (e.g., Bluetooth) capability and low power, long-range, infrastructure-free network radio networking capabilities for a purpose of adapting the legacy short-range headset to at least one low power, long-range, infrastructure-free wireless network enabling direct communication to other similarly equipped headsets, as detailed herein in connection with one or more embodiments.

Also, at least one embodiment can include at least one radio speaker microphone (RSM) equipped with the wireless low power, long-range, infrastructure-free network radio capabilities and/or solution for purposes of replacing cables and/or short-range wireless technologies to support direct RSM-to-RSM multi-way communications without the need for dedicated two-way radios and/or associated network infrastructure. By way merely of illustration, an example wired RSM, as used herein, can contain at least one speaker, at least one microphone, at least one housing component, at least one push-to-talk button (or similar communication mechanism), and at least one cable. Alternatively, a wireless RSM, as used herein in connection with one or more embodiments, can include at least one radio transceiver, at least one antenna, and software implementing the wireless low power, long-range, infrastructure-free network radio capabilities and/or solution detailed herein.

Additionally, one or more embodiments include configuring at least one relay node in connection with wireless headsets for purposes of providing network repeater functionality for certain mesh networking use cases. By way of example, in such an embodiment, a relay node receives a transmission from one source device (e.g., a wireless headset) and forwards the transmission to at least one destination device (e.g., at least one other wireless headset). In one or more embodiments, such a relay node itself could be another wireless headset that is in range of both the source and destination devices, and may be placed into a dedicated relay and/or repeater mode of operation. Accordingly, in at least one example embodiment, while source and destination devices (e.g., wireless headsets) may not be within range of each other, if both devices are in range of the relay node (e.g., another wireless headset), the range between such devices can be significantly increased (e.g., doubled).

As another example, one or more embodiments can include configuring at least one wired or wireless intercom unit with the wireless low power, long-range, infrastructure-free network radio capabilities detailed herein. Conventional fixed wired and wireless intercom systems, in contexts wherein long-range capabilities or the ability to work indoors is necessary, are typically used in buildings to communicate between different rooms or between different floors. Conventional mobile wireless intercom systems are often used at large events such as, e.g., used by security personnel at concerts. Conventional fixed wired systems suffer at least in part from a need to install wiring throughout a structure (e.g., a building desired for use) and to provide infrastructure such as amplifiers to drive the wiring. Both types of conventional wireless intercom systems suffer from the need for infrastructure typically near the center of the event and/or venue. Accordingly, in one or more embodiments, a wireless intercom configured with the same or similar wireless infrastructure-free network radio capabilities detailed herein can include, e.g., at least one radio transceiver, at least one antenna, a push-to-talk switch and software implementing the wireless low power, long-range, infrastructure-free network radio capabilities detailed herein.

Example and/or illustrative embodiments of the invention will be described herein with reference to exemplary networks and associated computers, servers, network devices or other types of processing devices. It is to be appreciated, however, that the invention is not restricted to use with the particular illustrative network and device configurations shown. By way of example, the term “network” as used herein is intended to be broadly construed, so as to encompass, for example, any system comprising multiple networked processing devices.

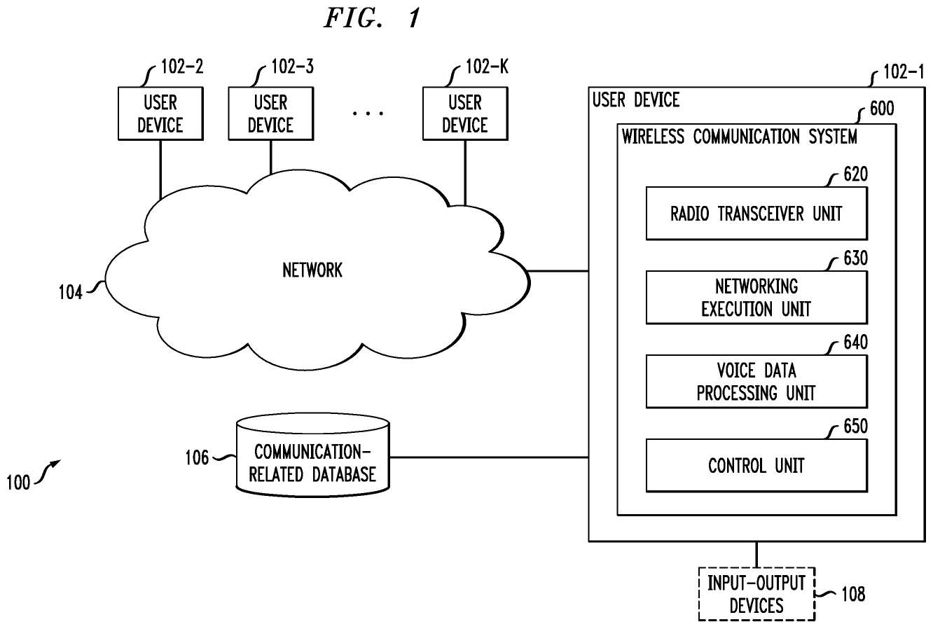

FIG. 1 shows a network 100 configured in accordance with an example embodiment of the invention. The network 100 includes a plurality of user devices 102-1, 102-2, 102-3, . . . 102-K, collectively referred to herein as user devices 102. The user devices 102 are coupled to a network 104, where the network 104 in such an embodiment is assumed to represent a sub-network or other related portion of the larger network 100. Accordingly, elements 100 and 104 are both referred to herein as examples of “networks,” but element 104 is assumed to be a component of element 100 in the context of the FIG. 1 embodiment.

The user devices 102 can include, for example, wireless headsets, RSMs (e.g., wireless RSMs), dongles (e.g., wireless dongles), relay nodes, and/or one or more other communication-related devices. The user devices 102, as illustrated in FIG. 1, can connect, via wireless communication system 600, to one or more of the other user devices 102 (which also contain at least one instance of wireless communication system 600) via network 104.

By way merely of illustration, in the example embodiment depicted in FIG. 1, wireless communication system 600 is shown as resident on user device 102-1, but it is to be appreciated (and as further detailed herein) that other arrangements and/or configurations of the wireless communication system 600 and user devices 102 can be implemented.

Similarly, in at least one embodiment wherein wireless communication system 600 is part of and/or resident on user device 102 (such as shown in FIG. 1), the wireless communication system 600 in the FIG. 1 embodiment can be implemented using at least one processing device. Each such processing device can include at least one processor and at least one associated memory and can implement one or more functional software modules or components for controlling certain features of the wireless communication system 600. Also, in at least one embodiment of the invention, wireless communication system 600 can be coupled to a power source (e.g., at least one battery, etc.).

Additionally, in one or more embodiments, the wireless communication system 600 and/or user devices 102 can include a processor coupled to a memory. The processor can include, for example, a microprocessor, a microcontroller, an application-specific integrated circuit, a field-programmable gate array or other types of processing circuitry, as well as portions or combinations of such circuitry elements. The memory can include, for example, random access memory (RAM), read-only memory (ROM) or other types of memory, in any combination. The memory and other memories disclosed herein can also be viewed as examples of processor-readable storage media, which can store executable computer program code and/or other types of software programs.

Examples of such processor-readable storage media can include, by way merely of example and not limitation, a storage device such as a storage disk, a storage array or an integrated circuit containing memory, as well as a wide variety of other types of computer program products. The term “processor-readable storage media” as used herein should be understood to exclude transitory, propagating signals.

As also detailed herein, wireless communication system 600 facilitates communication (e.g., communication by user devices 102) over the network 104 with other wireless communication systems and/or user devices, and can include, for example, one or more radio transceivers. In one or more embodiments, such a radio transceiver includes a radio providing the wireless connectivity to an infrastructure-free network such as further detailed herein.

Additionally, the wireless communication system 600 and/or user devices 102 can be coupled to one or more additional devices such as, for example, other user devices (including, e.g., mobile telephones, laptop computers, tablet computers, desktop computers or other types of computing devices).

The user devices 102, in one or more embodiments of the invention, can be coupled to respective computers and/or mobile devices associated with a particular group, organization or other enterprise. Numerous other operating scenarios involving a wide variety of different types and arrangements of processing devices and networks are possible, as will be appreciated by those skilled in the art.

Also, it is to be appreciated that the term “user” herein is intended to be broadly construed so as to encompass, for example, human, hardware, software or firmware entities, as well as various combinations of such entities.

The wireless communication system 600 and/or user devices 102 can also have an associated communication-related database 106 configured to store data related to one or more user devices 102, transmission information, communication mode information, temporal information, etc. In at least one embodiment of the invention, communication-related database 106 can be implemented using one or more storage systems associated with the wireless communication system 600 and/or user devices 102. Such storage systems can comprise any of a variety of types of storage including network-attached storage, storage area networks, direct-attached storage and distributed direct-attached storage, as well as combinations of these and other storage types, including software-defined storage.

Also optionally associated with the wireless communication system 600 and/or user devices 102 can be one or more input-output devices 108, which can include, by way merely of example, keyboards, displays or other types of input-output devices in any combination. Such input-output devices can be used to support one or more user interfaces (UIs) to the wireless communication system 600 and/or user devices 102, as well as to support communication between the wireless communication system 600 and/or user devices 102 and other related systems and devices not explicitly illustrated in FIG. 1.

As also depicted in FIG. 1 and detailed further herein, wireless communication system 600 includes radio transceiver unit 620, networking execution unit 630, voice data processing unit 640 and control unit 650.

It is to be appreciated that this particular arrangement of elements 620, 630, 640 and 650 illustrated in the processor of the FIG. 1 embodiment is presented by way of example only, and alternative arrangements can be used in one or more other embodiments of the invention. For example, the functionality associated with elements 620, 630, 640 and 650 in other embodiments can be combined into a single module or separated across a number of modules. By way of further example, multiple distinct processors can be used to implement different ones of elements 620, 630, 640 and 650, or portions thereof.

Also, at least portions of elements 620, 630, 640 and 650 can be implemented at least in part in the form of software that is stored in memory and executed by a processor.

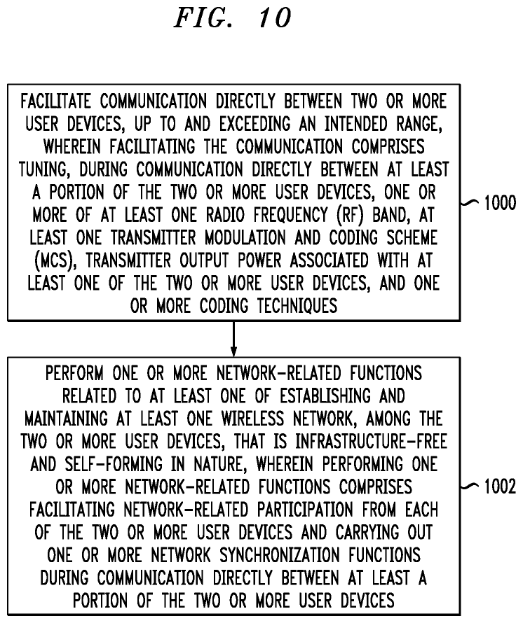

Further, an example process utilizing elements 620, 630, 640 and 650 of wireless communication system 600 in network 100 is described below, including in connection with the description of FIG. 10.

It is to be understood that the particular set of elements shown in FIG. 1 for implementation of wireless communication systems with low power, long-range, infrastructure-free networking capability is depicted by way of illustrative example only, and in one or more other embodiments of the invention, additional or alternative elements may be used.

By way merely of example, in one or more other embodiments of the invention, the wireless communication system 600 can be eliminated and associated elements such as elements 620, 630, 640 and 650 can be implemented elsewhere in network 100.

At least one embodiment of the invention includes wireless communication systems with low power, long-range, infrastructure-free networking capability. Such an embodiment, by way of example, can be implemented in various headset use cases (e.g., portable radios, public safety-related devices, commercial aviation headsets, commercial air, land and/or sea vehicle intercom systems, listening to audio content and/or video content, etc.).

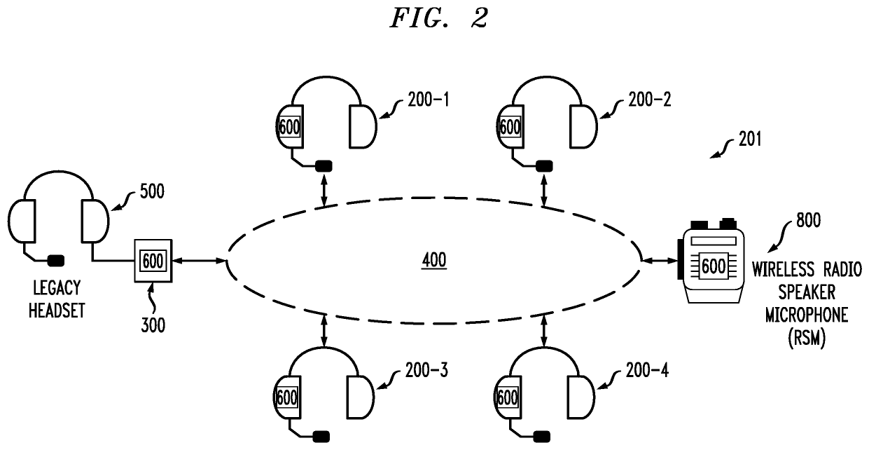

FIG. 2 is a diagram illustrating a wireless headset network system in an example embodiment of the invention. By way of illustration, FIG. 2 depicts a low power, long-range, infrastructure-free wireless headset network system 201 which does not require the use of a mesh topology. Infrastructure-free wireless headset network system 201 includes wireless headsets 200-1, 200-2, 200-3 and 200-4 (collectively referred to herein as wireless headsets 200), a dongle 300 and an RSM 800 all equipped with a wireless communication system 600. The dongle 300, as detailed herein, enables legacy headset 500 (e.g., a cabled headset and/or a short-range wireless headset) to be connected to the infrastructure-free wireless headset network system 201.

In the example embodiment depicted in FIG. 2, wireless headsets 200 are each configured with wireless communication system 600, providing the wireless headsets 200 with low power, long-range, infrastructure-free wireless communications capability. Once configured, each wireless headset 200 is capable of becoming a communication network node. A wireless network 400, depicted in FIG. 2 and represented by the dashed-line oval, is dynamically created without any base stations, network controllers and/or other type(s) of infrastructure or communication arbiters whenever two or more network nodes (e.g., wireless headsets 200) are powered up and brought within range of each other to join the wireless network 400.

Once wireless network 400 is formed, any two or more network nodes that are successfully joined to the wireless network 400 are able to securely communicate with each other. One or more additional wireless headsets 200 that have also been previously configured for wireless network 400 can join the wireless network 400 (e.g., at any time). In a similar fashion, one or more of the wireless headsets 200 can also leave the wireless network 400 (e.g., at any time).

In at least one embodiment, dongle 300 (e.g., a wireless dongle) is also configured with wireless communication system 600 and can represent another network node type. Also, legacy headset 500 can then be attached (e.g., via a cable or wirelessly) to dongle 300, which then acts as a network adapter to enable legacy headset 500 to connect to wireless network 400 with the same wireless infrastructure free, low power, long-range communications capability as wireless headsets 200.

Additionally, as also depicted in FIG. 2, one or more embodiments can include wireless RSM 800 configured with wireless communication system 600, representing yet another network node type. Wireless RSM 800 can then be used for wireless infrastructure free, low power, long-range communications capability, similar to wireless headsets 200.

In one or more embodiments, the wireless communication system 600 associated with wireless headsets 200, wireless dongle 300 and wireless RSM 800 are setup and/or configured prior to the first usage. Configuring the wireless communication system 600 can include, for example, an initial setup of one or more network parameters and/or options, providing one or more cryptographic keys for secure communications and other parameters specific to the product application and/or use case. Once a node (e.g., a device) is configured, the node is able to form an instance of wireless network 400 during power-up together with other nodes that are within range of each other and configured in the same manner. Additionally, in such an embodiment, various devices and/or types of devices, provided that each has been configured with wireless communications system 600 and configured in a similar manner, are all able to communicate with each other while joined to wireless network 400.

As further detailed herein, one or more embodiments can include implementing support for one or more vocoders (for example, OPUS, G.722, LC3, LC3+, MELPe, etc.). Also, at least one embodiment can include functioning (e.g., transmitting data across multiple wireless headsets and/or other devices) over a long range which can be at least in part based upon the radio type implemented in the wireless communications system 600 (e.g., LoRa, DECT NR+, etc.) and/or the corresponding radio frequency (RF) spectrum (e.g., 915 MHz for LoRa, 1.9 GHz for DECT NR+, etc.), in a single hop (e.g., without mesh routing). In such an embodiment, range and data quality (e.g., voice quality) can be traded off depending, for example, upon a physical layer (PHY) option, RF spectrum band, selected vocoder option(s), etc.

One or more embodiments can also include implementing support for private communication (e.g., person-to-person), group communications (e.g., between multiple users on a network, but not all users), and/or broadcast communications (e.g., between all users on a network). In such an embodiment, support for multiple communication modes can include half-duplex push-to-talk (PTT) voice transmission and full-duplex “AllTalk” voice transmission, wherein all users on a given network can communicate in a fully conversational manner. Additionally, at least one embodiment includes implementing support within the headset(s) for multi-channel communications on the same network. By way of example, such an embodiment can include configuring wireless communication system 600 with multiple (e.g., two) distinct and separate channels to route one group of talkers (e.g., an “A” squad) on wireless network 400 to the left earcup of a given headset and route other talkers (e.g., a “B” squad) on the wireless network 400 to the right earcup of the given headset. By way of further example, configuring wireless communication system 600 in the full-duplex “AllTalk” voice transmission mode can include prioritizing specific talkers (e.g., a group leader) to be heard at a higher volume and/or to cause lower priority talkers to be muted whenever a higher priority talker speaks.

Also, at least one embodiment includes implementing support for a secure voice network wherein wireless headset 200, dongle 300 and RSM 800 network node types are all admitted to the network via at least one cryptographic key exchange security mechanism, and wherein all communications control and traffic information is encrypted using at least one encryption technology (e.g., AES-256). In addition, users can be authenticated to use specific devices using, for example, personal identification number (PIN) code entry methods and/or voice fingerprinting methods wherein upon powering-up the device, the user speaks into the microphone of the device and the device compares the speaker's voice to a stored sample (i.e., a voice “fingerprint” of the user) of previously authorized user voice data to unlock the device for use.

Additionally or alternatively, one or more embodiments include implementing support for special purpose audio digital signal processing (DSP) within, e.g., wireless headsets 200, dongle 300 and wireless RSM 800 for voice activity detection (VAD), acoustic echo cancellation (AEC), and/or other DSP algorithms to improve audio quality, device usability and/or overall user experience, as well as to minimize unwanted sound and/or noise.

Further, at least one embodiment includes implementing support for simultaneous voice and data communications protocols, wherein a portion of each communication frame is dedicated to voice timeslots and at least a portion of the rest of the communication frame is available for non-voice data timeslots. By way of example, for voice timeslots, each talker on the network is assigned a specific logical communications channel with a unique set of channel parameters indicated by at least one or more (in the case, e.g., of frequency hopping) radio frequencies, a hopping sequence (in the case, e.g., of frequency hopping) and an assigned timeslot within each communication frame in a time division multiple access (TDMA) manner.

In one or more embodiments, and referring again to FIG. 2, wireless headsets 200, wireless dongle 300 and wireless RSM 800 can be further configured with additional non-voice capabilities to provide information (e.g., high value information) via the data communications portion of the wireless network 400 protocol to other users on/in the network and/or via at least one gateway to provide at least a portion of the information to one or more interested parties.

By way merely of example, such an embodiment can include equipping a wireless headset 200 with a GNSS receiver such that the wireless headset 200 can determine and track the user's position and report PLI to one or more interested parties. Another example embodiment can include providing a backhaul communications link to connect a group member's body area network (e.g., including group member vitals, equipment sensors (such as, for example, a firefighter's oxygen tank level), live video streams, etc.) to one or more interested parties. By way of further example, such an embodiment can include obtaining safety critical information of the user's surrounding environment and sharing such information via wireless network 400 such that notice of unsafe situations can be output via the headsets in the form of an audio alarm and/or displayed on group members' heads-up display (HUD). Also, yet another example embodiment can include configuring wireless headsets 200, dongle 300 and RSM 800 with one or more accelerometer sensors and/or electronic compass sensors connected to wireless communication system 600 for the purposes of providing data (e.g., fall and/or shock data related to the accelerometer and the user's bearing information related to the compass as part of a PLI report) through the data communications portion of the wireless network 400 to one or more interested parties.

As also detailed herein, one or more embodiments includes enabling wireless network 400, via wireless communication system 600, to support voice and data traffic simultaneously. Such headset-to-headset voice and data networking capability can be beneficial for many use cases (e.g., for soldiers, added data capability can be used for sharing critical information required during a mission such as PLI, wireless headsets 200 being configured to act as a gateway to a soldier's body area network in order to backhaul soldier sensor data such biometric vitals, etc., for monitoring of health and/or safety parameters. By way of further example, workers in high-risk environments (e.g., oil refineries, underground and/or open pit mines, petrochemical plants, commercial aviation grounds, etc.) often require hearing protection and work with equipment that needs to be monitored for personnel safety and/or regulatory compliance. For example, consider a team of firefighters wearing oxygen tanks while fighting a fire. In such an example, it is imperative that the oxygen tanks be monitored to ensure oxygen levels are adequate while they are fighting the fire, and at the same time, the firefighters will need to communicate with each other and with a command center monitoring their progress in fighting the fire. For rural wildfire firefighting efforts, it may similarly be of vital importance to know each firefighter's physical location while being in direct communication with each firefighter over long ranges and wherein communications infrastructure may not exist and/or be readily accessible. In such a scenario, voice communications, GNSS and PLI can be shared between firefighters and with a command center via a gateway equipped with wireless communications system 600 for the purpose of connecting wireless network 400 to another network such as, for example, a private IP network or the public internet.

Accordingly, the above are merely examples intended to illustrate the capability of one or more embodiments to combine voice and data communications over long ranges in infrastructure-challenged locations.

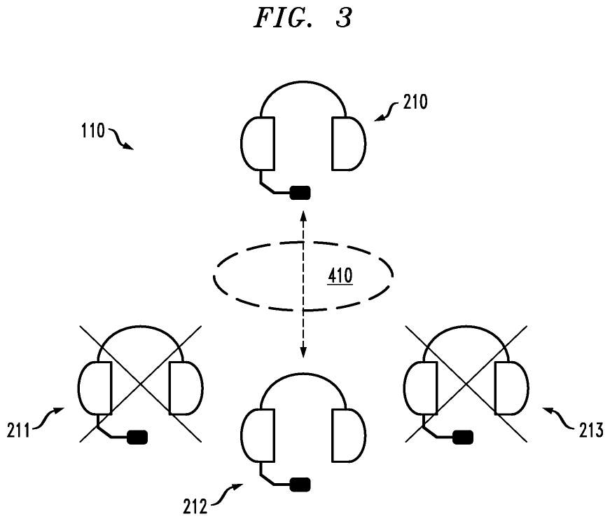

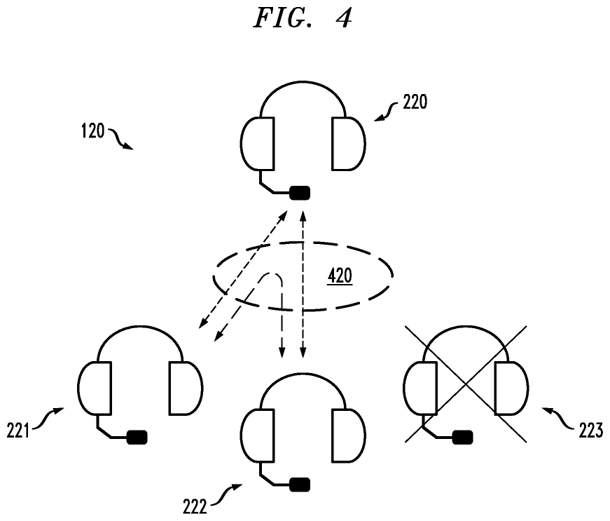

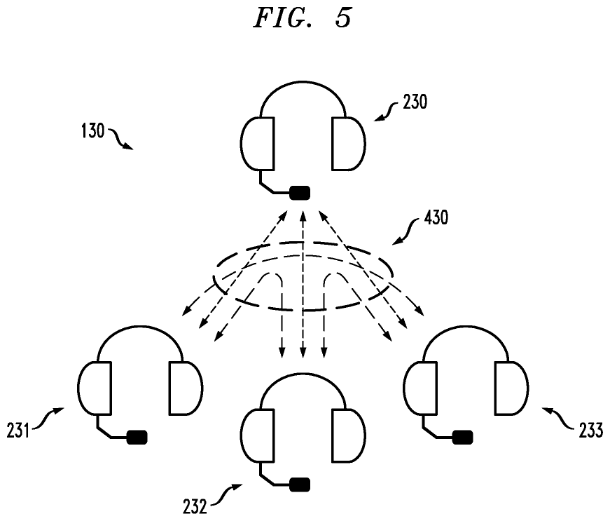

As further detailed below and herein, FIG. 3, FIG. 4 and FIG. 5 illustrate different direct (e.g., non-mesh) voice communication modes supported by one or more embodiments.

FIG. 3 is a diagram illustrating a private person-to-person communication mode within a wireless network in an example embodiment of the invention. By way of illustration, FIG. 3 depicts a point-to-point and/or person-to-person private communication network configuration 110. In this depicted example, wireless headsets 210, 211, 212 and 213 are actively joined to wireless network 410. However, a private communication session is established between wireless headsets 210 and 212 only. Wireless headsets 211 and 213, even though they are actively joined to wireless network 410, cannot hear the conversation and cannot communicate with wireless headsets 210 and 212 while the private person-to-person communication mode is engaged and/or enabled. In one or more embodiments, a private person-to-person communication mode can be carried out via one or more user interface-based methods. For example, such a method can include utilizing one or more buttons on the headset(s) in some type of designated sequence to set up a call type and select a subset of users from all users on the network. By way of further example, another such method can include using one or more voice commands recognized by a processor in wireless communications system 600. Yet another such method can include achieving call setup and termination using a mobile device application associated with the given wireless headset(s) and a wireless connection between such mobile device(s) and corresponding headset(s).

FIG. 4 is a diagram illustrating a group communication mode within a wireless network in an example embodiment of the invention. By way of illustration, FIG. 4 depicts a group communication mode within wireless network 420 wherein three or more, but not the entire set of active users, can participate in a conversation. Specifically, FIG. 4 depicts a point-to-multi-point, or group communication network configuration 120, wherein wireless headsets 220, 221, 222 and 223 are actively joined to wireless network 420, and a group communication session is established between wireless headsets 220, 221 and 222 only. Wireless headset 223, even though it is actively joined to wireless network 420, cannot communicate with the rest of the group while the group communication mode is engaged and/or enabled. In one or more embodiments, a group communication mode can be carried out via one or more user interface-based methods, such as detailed above.

FIG. 5 is a diagram illustrating a communication mode within a wireless network wherein all active users can participate in an example embodiment of the invention. By way of illustration, FIG. 5 depicts network configuration 130 wherein all active nodes (e.g., devices) that are joined to the wireless network 430 are included in the communication. Specifically, FIG. 5 depicts wireless headsets 230, 231, 232 and 233, which represent all active nodes joined to the wireless network 430 at a given time, and wherein all such nodes able to communicate with each other.

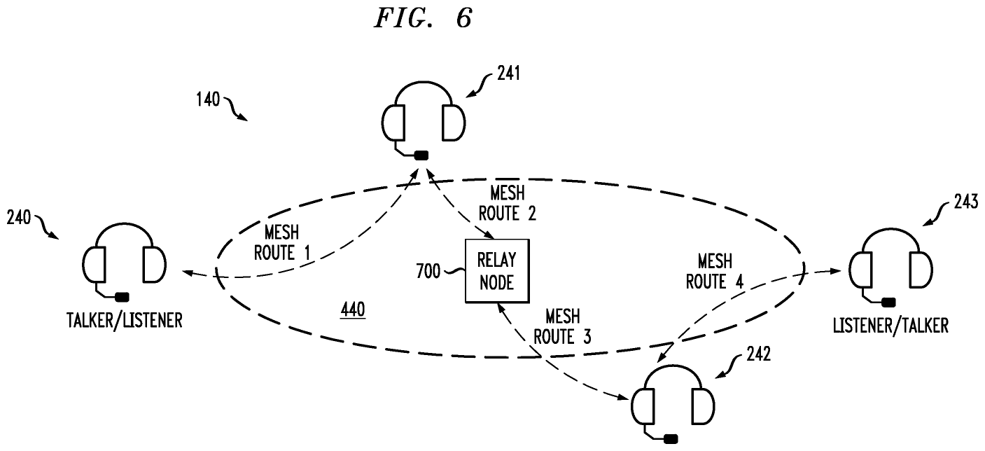

FIG. 6 is a diagram illustrating a wireless network system configured to operate as a mesh network in an example embodiment of the invention. Specifically, FIG. 6 depicts network system 140 configured to operate as a mesh network, wherein network system 140 includes a relay node 700 to extend communications, for example, in difficult radio environments (e.g., above ground to underground communications, communications around RF-impenetrable barriers, etc.). In one or more example embodiments, relay node 700 can include mesh operation software, and once configured to operate as mesh, all relevant nodes (e.g., devices) can operate as mesh nodes and call routing can be handled by one or more mesh routing algorithms in an infrastructure-free networking software stack. In at least one example embodiment, a wireless headset itself can operate as a relay or a repeater node (as could a dongle or RSM). Accordingly, as illustrated in FIG. 6, wireless network 440 is configured to operate using mesh routing for extending range (e.g., beyond what is possible in direct (i.e., non-mesh) communication modes). Another advantage of such an embodiment utilizing mesh topology for a network of wireless headsets (e.g., wireless headsets 240, 241, 242 and 243) is enabling and/or facilitating each wireless headset to transmit at a lower power level while still achieving the same or longer range.

In certain contexts, a penalty associated with mesh topology is increased system latency. However, a benefit of lower transmit power is realized through increased battery life for battery powered nodes (e.g., devices) and, for given applications, a lower probability of detection. Also, it is to be noted that, in accordance with one or more embodiments, implementing mesh topology enables all of the communication modes detailed in connection with FIG. 3, FIG. 4 and FIG. 5 (e.g., private communication mode, group communication mode, and all devices communication mode).

By way merely of example, FIG. 6 shows a private communication session established between wireless headset 240 and wireless headset 243. In this configuration, wireless network 440, which is formed by all active nodes (e.g., devices) on the network (i.e., wireless headsets 240, 241, 242 and 243, and relay node 700), routes the voice conversation from wireless headset 240, through wireless headset 241, through relay node 700, through wireless headset 242, and finally to wireless headset 243, which is the addressed recipient. When wireless headset 243 talks to wireless headset 240, the traffic is routed in the reverse direction. It is important to note that the routing between nodes (e.g., wireless headsets) is dynamic and can change based at least in part on numerous factors including, but not limited to, movement of the nodes within the network, change(s) in the radio environment, failure of a node, etc.

Relay node 700, as depicted in FIG. 6, can include one or more instances of wireless communication system 600. In one or more embodiments, relay node 700 can be at least in part similar to wireless headsets 200 and dongle 300. However, relay node 700 is not required to support the headset speaker and microphone audio interfaces (although any headset or dongle can be configured as a relay node). A purpose, in such an embodiment, of relay node 700 is to relay voice and/or data traffic between two other nodes (e.g., devices) in the network system 140. By way of example, consider a group which splits up into two teams: one team is required to go below ground into a basement or tunnel, while the other team remains above ground. In order to ensure that the two teams can stay connected with voice and/or data communications, a relay node 700 can be placed at and/or near the entrance to the tunnel or basement to keep the two teams connected. It is important to note in such a relay node use case that all nodes, including the relay node, are joined to the same wireless network (e.g., wireless network 440). As an extension of this use case, a relay node with two instances of wireless communication system 600 can be configured as a gateway between two wireless networks.

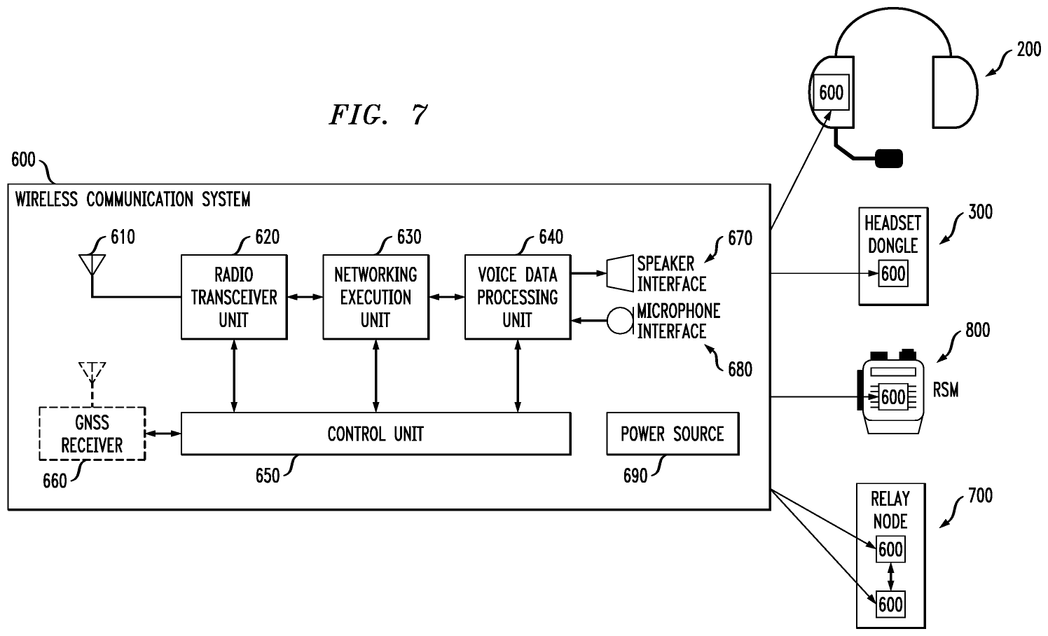

FIG. 7 is a diagram illustrating a block diagram of a wireless communication system in an example embodiment of the invention. By way of illustration, FIG. 7 depicts a block diagram of at least one embodiment which includes wireless communication system 600 for use integrated into a wireless headset 200, integrated into dongle 300 (e.g., to support legacy headsets), integrated into an RSM 800 (e.g., to support legacy headsets), and integrated into a relay node 700 (e.g., for use in a mesh topology). In such an embodiment, the same or very similar wireless communication system 600 can be used within wireless headset 200, dongle 300, RSM 800 and relay node 700.

As depicted in the example embodiment of FIG. 7, wireless communication system 600 can include wireless antenna 610, which can be configured to transmit and receive in the RF spectrum band required by radio transceiver unit 620. Radio transceiver unit 620 can be configured with at least one PHY option optimized for the particular node (e.g., device) use case and can be configured for long-range communications capabilities. It is also to be noted, and appreciated by one skilled in the art, that all devices intended to operate together within a particular network configuration must be configured with the same PHY option.

Referring again to FIG. 7, and more specifically, to wireless communication system 600, networking execution unit 630 is configured to perform network functions such as described herein including, but not limited to, network formation, addressing, routing (including mesh routing), security, etc. Networking execution unit 630 can be further configured to adapt to the selected PHY option of radio transceiver unit 620. Further, in one or more embodiments, networking execution unit 630 can include algorithms for one or more infrastructure-free networking capabilities such as, for example, network creation, network security, quality of service (e.g., traffic priority), traffic routing, network synchronization, etc.

Additionally, voice data processing unit 640 is configured with at least one appropriate vocoder as well as digital-to-analog (DAC) and analog-to-digital (ADC) converters required to input audio data from microphone interface 680 as spoken by the device user and output high quality audio data coming from the low power, long-range, infrastructure-free wireless network to a speaker interface 670. Control unit 650 provides overall control of the end user device (e.g., wireless headset 200, dongle 300 and/or relay node 700) in connection with, for example, user experience and/or specific product or enterprise logic. In one or more embodiments, control unit 650 can be configured to control one or more features detailed herein at the radio PHY level, at the networking level and/or at the application (e.g., product) level such as, for example, accepting command input from a user interface and providing status information to a user interface. Command input can include, for example, input via push buttons, touch prompts, voice commands and/or other means of providing device-level human interface controls. Additionally, status information can be provided, for example, via one or more light-emitting diodes (LEDs), one or more displays, one or more voice prompts and/or other means of presenting status information to a device user.

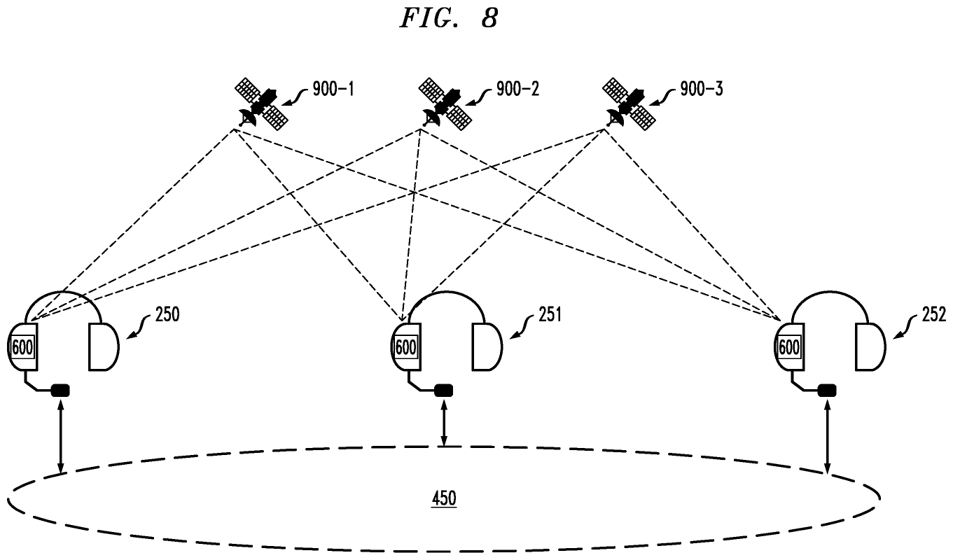

FIG. 7 also depicts, as part of wireless communication system 600, power source 690 (e.g., at least one battery) and optional GNSS receiver 660 and its associated antenna. GNSS receiver 660 can represent an example of how one or more embodiments can be implemented for simultaneous voice and data applications, which is further illustrated in connection with FIG. 8. In FIG. 7, the GNSS receiver 660 can receive and process satellite position information from one or more (e.g., at least three visible) GNSS satellites in order to compute the position of the user wearing wireless headset 200, dongle 300, RSM 800, or relay node 700. In at least one embodiment, control unit 650 receives such position information and passes it to network execution unit 630, wherein the information is incorporated into the infrastructure-free network message protocol for transmission to other user devices along with voice information via radio transceiver unit 620. It should be noted and acknowledged by one skilled in the art that GNSS receiver 660 can be interfaced to one or more other functions within the wireless communications system 600 such as networking execution unit 630, radio transceiver unit 620, etc.

Additionally, it is noted and to be acknowledged by one skilled in the art that, in one or more embodiments, GNSS receiver 660 can be included in wireless communications system 600, or GNSS receiver 660 can be external to wireless communications system 600 (e.g., soldered onto another printed circuit board to which wireless communications system 600 is also soldered onto), provided that an appropriate data interface is used to attach an external GNSS receiver to wireless communications system 600.

FIG. 8 is a diagram illustrating using a wireless headset network to act as a data network for sharing location information in an example embodiment of the invention. By way of illustration, FIG. 8 depicts an example embodiment which includes using a wireless headset network to act as a data network for sharing location information. Specifically, FIG. 8 depicts wireless headsets 250, 251 and 252 joined to infrastructure-free wireless network 450 (e.g., in the same manner as is shown in the exemplary embodiment of FIG. 2). In connection with the example embodiment of FIG. 8, each wireless headset's GNSS receiver (e.g., component 660 in FIG. 7) is receiving position and/or location information from GNSS satellites 900-1, 900-2 and 900-3 (collectively referred to herein as GNSS satellites 900), and computing the precise position of the given wireless headset.

During such a time as depicted in FIG. 8, each wireless headset wearer is able to communicate verbally with the two other headset wearers that are joined to the infrastructure-free wireless network 450. Simultaneously with such voice conversations, infrastructure-free wireless network 450 is sharing among the connected wireless headsets, the above-noted location data, in the form of wireless data, of the other headset wearers joined to the infrastructure-free wireless network 450. Such location data (e.g., PLI) of one or more of the wireless headsets (e.g., all wireless headsets) joined to infrastructure-free wireless network 450 can be presented to a given headset wearer in different ways, such as, for example, via at least one voice prompt (e.g., “Joe is 100 meters away from you to the northeast”), via at least one HUD that is coupled with the headset electronics, via the wireless headset wearer's smartphone that is also joined to infrastructure-free wireless network 450 via a dongle 300 that is used to connect the smartphone to infrastructure-free wireless network 450, etc. It is to be noted and appreciated by one skilled in the art that multiple types of non-voice data, as detailed herein, can be transferred in parallel with verbal communications exchanged between wireless headset wearers on such a wireless network.

In order to share voice data, video data, and/or other data to and from a wider networking environment, one or more gateway devices can be configured that include an instance of wireless communications system 600 to provide connectivity between the infrastructure-free wireless network 450 and one or more heterogeneous networks such as private and/or public IP networks. The incorporation of gateway functionality to connect any of the wireless headset communication systems described herein can significantly extend the utility of such systems and can be used in various contexts. By way of example, such a context can include providing a management gateway function for remotely configuring, monitoring and/or updating software of the wireless communications system 600 within each of multiple wireless headset network nodes. Another example context can include providing inter-network gateway functionality to translate at least one protocol between the infrastructure free, low power, long-range protocol detailed herein in connection with one or more embodiments and at least one other heterogeneous networking protocol used by one or more networks on the other side of the gateway (e.g., IPv4, IPv6, etc.). Yet another example context can include providing an application gateway functionality for remote monitoring (e.g., sensor information, voice conversations, video feeds, etc.) and remote command and/or control of users and/or things interconnected within low power, infrastructure-free and long-range networks such as described herein. Further still, another example context can include, relating voice conversations held between users on an infrastructure free, low power, long-range wireless headset network such as detailed herein, a gateway used to enable one or more session initiation protocol (SIP) communication sessions over one or more IP networks between wireless headset users and, e.g., public or private internet clouds.

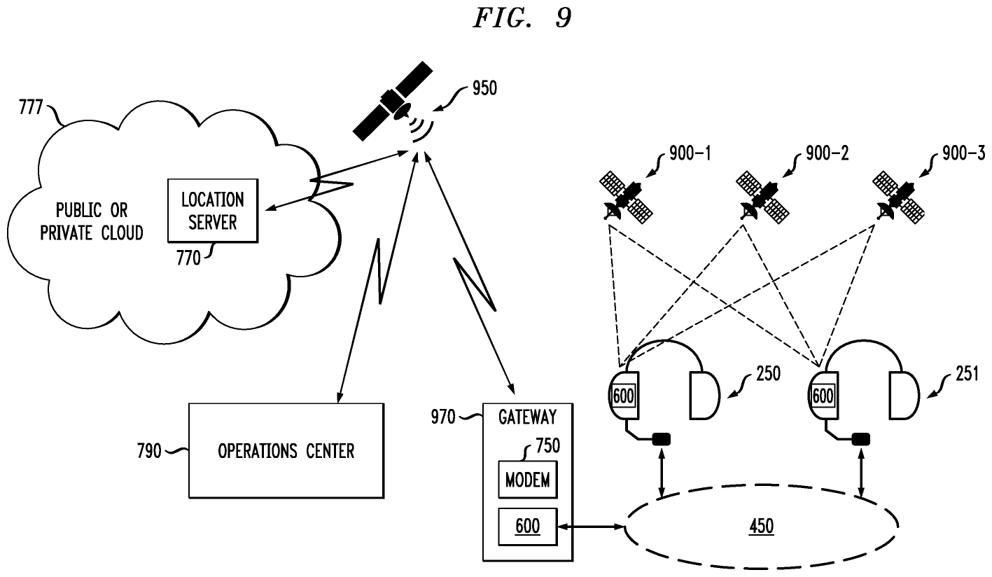

FIG. 9 is a diagram illustrating location data sharing in connection with a gateway in an example embodiment of the invention. By way of illustration, FIG. 9 depicts, similar to FIG. 8, wireless headsets 250 and 251, joined to infrastructure-free wireless network 450, and receiving position and/or location information from GNSS satellites 900-1, 900-2 and 900-3 (collectively referred to herein as GNSS satellites 900). As also depicted in FIG. 9, gateway 970 is configured with wireless communications system 600 to enable the gateway 970 to be joined to infrastructure-free wireless network 450. Gateway 970 is further configured with a satellite communications (SATCOM) modem 750 and relevant protocol translation capabilities to adapt the protocol of infrastructure-free wireless network 450 to that of a satellite communications system. The gateway 970 is then capable of providing direct wireless connectivity to a communications satellite 950.

As previously noted, many different types of gateways can be implemented to provide connectivity to/from infrastructure-free wireless network 450 and gateway 970 is depicted in FIG. 9 merely as an example. In this manner, voice and data traffic from infrastructure-free wireless network 450 can be transferred to/from the communications satellite 950, and the communications satellite 950 can then be configured to pass communications information from infrastructure-free wireless network 450 to numerous destinations, such as an operations center 790 (which can, e.g., represent a control center for various use case implementations). In the specific example embodiment of FIG. 9, location server 770 is installed in a public or private cloud 777. Additionally, location server 770 can host one or more systems (e.g., a situational awareness system) which can provide a centralized server for collecting and sharing PLI and other situational awareness information including, for example, map overlay imagery, etc.

Accordingly, with the gateway 970 connecting the location server 770 to infrastructure-free wireless network 450 via the SATCOM modem 750, wireless headsets 250 and 251 can report their position and ultimately access location server 770. Users associated with the operation center 790 can also access location server 770 and view the position/location information from users wearing wireless headsets 250 and 251, as well as additional location-based information (e.g., real-time position of other users and/or devices displayed on a related geographical map).

By way of example, in at least one embodiment wherein a wireless headset user also has a smartphone joined to infrastructure-free wireless network 450 via a wireless dongle, the smartphone can receive situational awareness information (e.g., a map display showing positional information for one or more related users and/or devices) from location server 770 and display it on the smartphone display without the need for a cellular or Wi-Fi network connection. In such an embodiment and use case example, the location server 770 can provide robust situational awareness capability to each group member (e.g., users associated with wireless headsets 250 and 251) via the gateway 970 than what might be attainable with only the isolated infrastructure-free wireless network 450.

FIG. 10 is a flow diagram of a process for implementing wireless communication systems with low power, long-range, infrastructure-free networking capability in an example embodiment of the invention. In this embodiment, the process includes steps 1000 and 1002. These steps are assumed to be performed by wireless communication system 600 utilizing elements 620, 630, 640 and/or 650.

Step 1000 includes facilitating communication directly between two or more user devices, up to and exceeding an intended range, wherein facilitating the communication includes tuning, during communication directly between at least a portion of the two or more user devices, one or more of at least one RF band, at least one transmitter MCS, transmitter output power associated with at least one of the two or more user devices, and one or more coding techniques.

With respect to tuning at least one RF band, one or more embodiments include utilizing and/or implementing a communication physical layer standard which provides a balance between the ability to use unlicensed spectrum on approximately a global basis, enables communication over long ranges (e.g., over at least one-half mile outdoors without obstruction(s)), and has limited congestion with respect to other users of the band. In such an embodiment, this particular RF band is the 1.8/1.9 gigahertz (GHz) frequency. By contrast, other RF spectrum, such as 2.4 GHz used by Bluetooth, Wi-Fi and other radio standards, can be heavily congested and introduce significant latency (e.g., because devices have to check for other devices transmitting on the same band before transmitting) and impact effective throughput on a wireless link. In connection with the above-noted communication physical layer standard, one or more embodiments can also include utilizing other RF bands such as, for example, the 915 megahertz (MHz) band, which can provide enhanced RF propagation characteristics (e.g., a longer range than the 1.8/1.9 GHz band).

With respect to tuning transmitter output power, one or more embodiments can include, for example, adjusting RF transmitter output power to the highest level permitted by spectrum regulatory authorities within a given region of operation to maximize range. For instance, in the European Union, a maximum output power of 24 decibel-milliwatts (dBm) is permitted in the 1880-1900 MHz frequency band. Other geographical regions have different maximum power restrictions and hence power levels must be adjusted based at least in part on region. Further, at least one embodiment can include adjusting transmitter output power dynamically based on, e.g., knowledge of required power level to reliably communicate with at least one destination device in order to improve and/or optimize the balance between range and power consumption.

With respect to tuning at least one transmitter MCS, one or more embodiments include modifying one or more different combinations of MCS parameters (also referred to as MCS levels) which can relate, for example, to the quality of one or more wireless channels. In at least one embodiment, in connection with implementing an infrastructure-free wireless network (meaning that there is no base station or other centralized infrastructure), MCS levels can be fixed across the network or determined collaboratively between two or more nodes (e.g., devices) communicating with each other. Additionally or alternatively, in one or more embodiments, MCS levels can be changed dynamically on a slot-by-slot basis, wherein a slot represents a number of individual bits and/or symbols transmitted serially (e.g., wherein there are 24 slots in a frame of 10 milliseconds in duration).

Modulation, as one MCS parameter, refers to the type of process used to modulate a carrier signal with digital information. Techniques used in conjunction therewith can include processes such as Phase Shift Keying (PSK), Quadrature Amplitude Modulation (QAM), etc. The higher order the modulation scheme used, the more densely the information is packed into the communication channel, resulting in higher data rates. To achieve longer range typically requires using lower order modulation techniques (i.e., less densely modulated waveforms).

Coding rate, another MCS parameter, refers to the error-correcting coding scheme used by the physical layer protocol. The lower the coding rate, the more redundant information can be added to the bitstream and the better the error resiliency. The higher the coding rate, the less redundancy is used, but the probability of errors occurring is also higher. Accordingly, for robust long-range communication, a lower coding rate is often used (which typically results in an impact on the data rate).

With respect to tuning one or more coding techniques, at least one embodiment includes using one or more Forward Error Correction (FEC) coding schemes in addition to at least one error-correcting coding scheme that is part of the corresponding physical layer standard and/or chipset to enhance error resiliency and improve range.

Accordingly, as detailed in connection with step 1000, for example, one or more embodiments can include implementing at least one algorithm (e.g., at least one networking algorithm) which can dynamically tune one or more of RF band, transmitter output power, MCS parameters and coding schemes and/or techniques to enhance range (e.g., maximize range) in an infrastructure-free wireless communication network.

Step 1002 includes performing one or more network-related functions related to at least one of establishing and maintaining at least one wireless network, among the two or more user devices, that is infrastructure-free and self-forming in nature, wherein performing one or more network-related functions includes facilitating network-related participation from each of the two or more user devices (e.g., wherein every node/device contains identical networking software which results in shared network management and control without centralized base stations, controllers, or the like) and carrying out one or more network synchronization functions during communication directly between at least a portion of the two or more user devices. In at least one embodiment, performing one or more network-related functions includes performing one or more network-related functions related to at least one of establishing and maintaining at least one wireless network in accordance with direct user device to user device topology, and/or performing one or more network-related functions related to at least one of establishing and maintaining at least one wireless network in accordance with at least one mesh topology. Additionally or alternatively, performing one or more network-related functions can include enabling direct and private user device-to-user device communication and/or enabling group communication amongst the two or more user devices on the at least one wireless network.

In one or more embodiments, the techniques depicted in FIG. 10 can also include outputting audio data associated with communication directly between at least a portion of the two or more user devices, wherein outputting audio data includes implementing at least one Time Division Multiple Access (TDMA) slotted medium access control (MAC) in connection with the at least one audio data processing unit, and implementing at least one voice coder operating in connection with at least one optimum sampling rate. The TDMA slotted MAC architecture breaks up a fixed duration communication frame into a number of time slots which are used by one or more devices on the network to share the transmission medium for communication of both voice/audio data and non-voice/audio data. A voice coder can be configured, for example, to receive a user's voice, digitize the audio and compress such audio at a sampling rate such as 16 kHz in order to transmit in a more compact and efficient manner while maintaining high voice/audio quality. A voice coder sampling rate can further be configured dynamically to optimize voice/audio quality for the available link capacity.

Additionally, at least one embodiment can also include authenticating an end-user prior to engaging a corresponding one of the two or more user devices by comparing stored voice data associated with the end-user to speech data input in connection with authenticating the end-user.

Other techniques can be used in association with one or more embodiments of the invention. Accordingly, the particular processing operations and other network functionality described in conjunction with FIG. 10 are presented by way of illustrative example only, and should not be construed as limiting the scope of the invention in any way. For example, the ordering of the process steps may be varied in one or more other embodiments of the invention, or certain steps may be performed concurrently with one another rather than serially. Also, the process steps or subsets thereof may be repeated periodically in conjunction with respective distinct instances of network communication with respect to different users and/or user devices.

Additionally, as detailed herein, one or more embodiments include a wireless communication system which includes at least one radio transceiver unit configured to facilitate communication, directly between two or more user devices up to and exceeding an intended range, wherein up to and exceeding an intended range, as used herein, refers to up to and exceeding approximately one kilometer in range. In such an embodiment, the wireless communication system encompasses long-range transmission capabilities and flexibility with respect to the number of users participating in the network based at least in part on the types of radios (e.g., DECT NR+, LoRa, etc.) in addition to one or more aspects and/or functionalities of the network execution unit.

In at least one embodiment, facilitating communication, directly between two or more user devices, up to and exceeding an intended range, includes tuning, during communication directly between at least a portion of the two or more user devices, one or more of at least one RF band (e.g., to reduce or minimize interference and/or increase or maximize one or more RF signal propagation characteristics), at least one transmitter MCS, transmitter output power associated with at least one of the two or more user devices, and one or more coding techniques (e.g., to enhance or optimize resiliency to one or more bit errors).

In one or more embodiments, the wireless communication system also includes at least one network execution unit configured to perform one or more network-related functions related to at least one of establishing and maintaining at least one wireless network, among the two or more user devices, that is infrastructure-free and self-forming in nature. In such an embodiment, performing one or more network-related functions includes facilitating network-related participation from each of the two or more user devices and carrying out one or more network synchronization functions during communication directly between at least a portion of the two or more user devices (e.g., ensuring network synchronization through at least one mutual sync function implemented with one or more synchronization events embedded within network traffic).

Additionally or alternatively, performing one or more network-related functions can include at least one of (i) performing one or more network-related functions related to at least one of establishing and maintaining at least one wireless network in accordance with direct user device to user device topology, and (ii) performing one or more network-related functions related to at least one of establishing and maintaining at least one wireless network in accordance with at least one mesh topology. In at least one embodiment, a mesh topology can extend pre-existing range further and/or allow the user devices to communicate at lower power levels for the same and/or pre-existing range. Use of a mesh topology can also enhance communication reliability through an ability to route traffic via multiple paths. Further, performing one or more network-related functions can include enabling simultaneous audio data communication (e.g., voice data) and non-audio data communication, as well as enabling direct and private user device-to-user device communication and enabling group communication amongst the two or more user devices on the at least one wireless network. Further still, performing one or more network-related functions can include performing mutual authentication of the two or more user devices during formation of the at least one wireless network (as well as rejecting unauthorized user devices during such formation), and performing encryption of at least a portion of communication between the two or more user devices (e.g., perform ongoing encryption of all network traffic).

In at least one embodiment, the wireless communication system can additionally include at least one audio data processing unit configured to output audio data associated with communication directly between at least a portion of the two or more user devices, In such an embodiment, outputting audio data includes implementing at least one TDMA slotted MAC in connection with the at least one audio data processing unit, and implementing at least one voice coder operating in connection with at least one given (e.g., optimum) sampling rate. The at least one audio data processing unit can, for example, process input audio data from at least one microphone interface and output at least a portion of the input audio data to at least one speaker interface, e.g., producing low-latency, high-quality speech and/or audio data. In such an embodiment, high-quality can refer, for example, to overall end-user experience in terms of reduced latency and increased quality of received speech and/or audio data. Additionally or alternatively, the at least one audio data processing unit can be configured with at least one digital-to-analog converter and at least one analog-to-digital converter.

Also, in at least one embodiment, the at least one audio data processing unit is further configured to authenticate an end-user prior to engaging a corresponding one of the two or more user devices by comparing stored voice data associated with the end-user (e.g., a voice fingerprint) to speech data input in connection with authenticating the end-user.

Further, in one or more embodiments, the wireless communication system is incorporated into at least one relay node in connection with at least one of one or more communication range extension operations and one or more communication operations in one or more radio frequency-impaired environments. Additionally, in at least one embodiment, the wireless communication system is incorporated into one or more of at least one dongle form factor, at least one radio speaker microphone, and at least one wireless intercom.

Also, in one or more embodiments, the wireless communication system can additionally include at least one data signal receiver (e.g., a GNSS receiver) and at least one associated antenna configured to perform one or more data application functions (e.g., for simultaneous voice and data applications). At least one embodiment can additionally include at least one gateway configured to connect the at least one wireless network to at least one additional network.

Further, one or more embodiments include a headset apparatus integrated with a wireless communication system such as detailed above and/or herein. Such an example headset apparatus includes at least one microphone element and at least one speaker element. The example headset apparatus also includes at least one radio transceiver unit configured to facilitate communication, directly between the headset apparatus and one or more user devices, up to and exceeding an intended range, wherein facilitating the communication includes tuning, during communication directly between the headset apparatus and at least a portion of the one or more user devices, one or more of at least one RF band, at least one transmitter MCS, transmitter output power associated with at least one of the headset apparatus and the one or more user devices, and one or more coding techniques.

Further, the example headset apparatus also includes at least one network execution unit configured to perform one or more network-related functions related to at least one of establishing and maintaining at least one wireless network, among the headset apparatus and the one or more user devices, that is infrastructure-free and self-forming in nature, wherein performing one or more network-related functions includes facilitating network-related participation from each of the headset apparatus and the one or more user devices and carrying out one or more network synchronization functions during communication directly between the headset apparatus and at least a portion of the one or more user devices.

The above-described example embodiments of the invention provide significant advantages relative to conventional approaches. For example, one or more embodiments of the invention can include implementing wireless headsets with low power, long-range, infrastructure-free networking capability.

It is to be appreciated that the foregoing advantages are illustrative of advantages provided in certain embodiments, and need not be present in other embodiments.

Additionally, the networks disclosed herein can be implemented, for example, using one or more processing platforms. Such a processing platform can include, by way of example, at least one processing device comprising a processor coupled to a memory.

In one or more embodiments of the invention, portions of a network as disclosed herein can illustratively utilize and/or access cloud infrastructure. The cloud infrastructure, in at least one such embodiment of the invention, can include a plurality of containers implemented using container host devices, and/or can include container-based virtualization infrastructure configured to implement Docker containers or other types of Linux containers.

The cloud infrastructure can additionally or alternatively include other types of virtualization infrastructure such as virtual machines implemented using a hypervisor. Additionally, the underlying physical machines include one or more distributed processing platforms that include one or more storage systems.

Such cloud infrastructure as described above can, by way of example, represent at least a portion of one processing platform. Another example of such a processing platform can include, as similarly detailed above in connection with FIG. 1, a plurality of processing devices which communicate with one another over a network. As yet another processing platform example, portions of a given processing platform in one or more embodiments of the invention can include converged infrastructure.

The particular processing platforms described above are presented by way of example only, and a given network such as network 100 can include additional or alternative processing platforms, as well as numerous distinct processing platforms in any combination, with each such platform comprising one or more computers, servers, storage devices and/or other processing devices.

Further, in accordance with one or more embodiments of the invention, processing devices and other network components can communicate with one another using a variety of different communication protocols and associated communication media.

It should again be emphasized that the embodiments of the invention described herein are presented for purposes of illustration only. Many variations may be made in the particular arrangements shown. Moreover, the assumptions made herein in the context of describing one or more illustrative embodiments of the invention should not be construed as limitations or requirements of the invention, and need not apply in one or more other embodiments of the invention. Numerous other alternative embodiments within the scope of the appended claims will be readily apparent to those skilled in the art.

What is claimed is:

1. A wireless communication system comprising:
at least one radio transceiver unit configured to facilitate communication, directly between two or more user devices, up to and exceeding an intended range, wherein facilitating the communication comprises tuning, during communication directly between at least a portion of the two or more user devices, one or more of at least one radio frequency (RF) band, at least one transmitter modulation and coding scheme (MCS), transmitter output power associated with at least one of the two or more user devices, and one or more coding techniques; and
at least one network execution unit configured to perform one or more network-related functions related to at least one of establishing and maintaining at least one wireless network, among the two or more user devices, that is infrastructure-free and self-forming in nature, wherein performing one or more network-related functions comprises facilitating network-related participation from each of the two or more user devices and carrying out one or more network synchronization functions during communication directly between at least a portion of the two or more user devices.

2. The wireless communication system of claim 1, further comprising:
at least one audio data processing unit configured to output audio data associated with communication directly between at least a portion of the two or more user devices, wherein outputting audio data comprises:
implementing at least one time division multiple access (TDMA) slotted medium access control (MAC) in connection with the at least one audio data processing unit; and
implementing at least one voice coder operating in connection with at least one optimum sampling rate.

3. The wireless communication system of claim 2, wherein the at least one audio data processing unit is further configured to authenticate an end-user prior to engaging a corresponding one of the two or more user devices by comparing stored voice data associated with the end-user to speech data input in connection with authenticating the end-user.

4. The wireless communication system of claim 1, wherein the wireless communication system is incorporated into one or more of at least one dongle form factor, at least one radio speaker microphone, and at least one wireless intercom.

5. The wireless communication system of claim 1, wherein the wireless communication system is incorporated into at least one relay node in connection with at least one of one or more communication range extension operations and one or more communication operations in one or more radio frequency-impaired environments.

6. The wireless communication system of claim 1, wherein performing one or more network-related functions comprises at least one of (i) performing one or more network-related functions related to at least one of establishing and maintaining at least one wireless network in accordance with direct user device to user device topology, and (ii) performing one or more network-related functions related to at least one of establishing and maintaining at least one wireless network in accordance with at least one mesh topology.

7. The wireless communication system of claim 1, wherein performing one or more network-related functions comprises enabling simultaneous audio data communication and non-audio data communication.

8. The wireless communication system of claim 1, wherein performing one or more network-related functions comprises performing mutual authentication of the two or more user devices during formation of the at least one wireless network and performing encryption of at least a portion of communication between the two or more user devices.

9. The wireless communication system of claim 1, wherein performing one or more network-related functions comprises at least one of enabling direct and private user device-to-user device communication and enabling group communication amongst the two or more user devices on the at least one wireless network.

10. The wireless communication system of claim 1, further comprising:
at least one gateway configured to connect the at least one wireless network to at least one additional network.

11. A headset apparatus comprising:
at least one microphone element;
at least one speaker element;
at least one radio transceiver unit configured to facilitate communication, directly between the headset apparatus and one or more user devices, up to and exceeding an intended range, wherein facilitating the communication comprises tuning, during communication directly between the headset apparatus and at least a portion of the one or more user devices, one or more of at least one RF band, at least one transmitter MCS, transmitter output power associated with at least one of the headset apparatus and the one or more user devices, and one or more coding techniques; and
at least one network execution unit configured to perform one or more network-related functions related to at least one of establishing and maintaining at least one wireless network, among the headset apparatus and the one or more user devices, that is infrastructure-free and self-forming in nature, wherein performing one or more network-related functions comprises facilitating network-related participation from each of the headset apparatus and the one or more user devices and carrying out one or more network synchronization functions during communication directly between the headset apparatus and at least a portion of the one or more user devices.

12. A computer-implemented method comprising:
facilitating communication directly between two or more user devices, up to and exceeding an intended range, wherein facilitating the communication comprises tuning, during communication directly between at least a portion of the two or more user devices, one or more of at least one RF band, at least one transmitter MCS, transmitter output power associated with at least one of the two or more user devices, and one or more coding techniques; and
performing one or more network-related functions related to at least one of establishing and maintaining at least one wireless network, among the two or more user devices, that is infrastructure-free and self-forming in nature, wherein performing one or more network-related functions comprises facilitating network-related participation from each of the two or more user devices and carrying out one or more network synchronization functions during communication directly between at least a portion of the two or more user devices;
wherein the method is carried out by at least one computing device.

13. The computer-implemented method of claim 12, further comprising:
outputting audio data associated with communication directly between at least a portion of the two or more user devices, wherein outputting audio data comprises:
implementing at least one TDMA slotted MAC; and
implementing at least one voice coder operating in connection with at least one optimum sampling rate.

14. The computer-implemented method of claim 13, further comprising:
authenticating an end-user prior to engaging a corresponding one of the two or more user devices by comparing stored voice data associated with the end-user to speech data input in connection with authenticating the end-user.

15. The computer-implemented method of claim 12, wherein performing one or more network-related functions comprises at least one of (i) performing one or more network-related functions related to at least one of establishing and maintaining at least one wireless network in accordance with direct user device to user device topology, and (ii) performing one or more network-related functions related to at least one of establishing and maintaining at least one wireless network in accordance with at least one mesh topology.

16. The computer-implemented method of claim 12, wherein performing one or more network-related functions comprises at least one of enabling direct and private user device-to-user device communication and enabling group communication amongst the two or more user devices on the at least one wireless network.

17. A non-transitory processor-readable storage medium having stored therein program code of one or more software programs, wherein the program code when executed by at least one processing device causes the at least one processing device to:
facilitate communication directly between two or more user devices, up to and exceeding an intended range, wherein facilitating the communication comprises tuning, during communication directly between at least a portion of the two or more user devices, one or more of at least one RF band, at least one transmitter MCS, transmitter output power associated with at least one of the two or more user devices, and one or more coding techniques; and
perform one or more network-related functions related to at least one of establishing and maintaining at least one wireless network, among the two or more user devices, that is infrastructure-free and self-forming in nature, wherein performing one or more network-related functions comprises facilitating network-related participation from each of the two or more user devices and carrying out one or more network synchronization functions during communication directly between at least a portion of the two or more user devices.

18. The non-transitory processor-readable storage medium of claim 17, wherein the program code when executed by the at least one processing device causes the at least one processing device to:
output audio data associated with communication directly between at least a portion of the two or more user devices, wherein outputting audio data comprises:
implementing at least one TDMA slotted MAC; and
implementing at least one voice coder operating in connection with at least one optimum sampling rate.

19. The non-transitory processor-readable storage medium of claim 17, wherein performing one or more network-related functions comprises at least one of (i) performing one or more network-related functions related to at least one of establishing and maintaining at least one wireless network in accordance with direct user device to user device topology, and (ii) performing one or more network-related functions related to at least one of establishing and maintaining at least one wireless network in accordance with at least one mesh topology.

20. The non-transitory processor-readable storage medium of claim 17, wherein performing one or more network-related functions comprises at least one of enabling direct and private user device-to-user device communication and enabling group communication amongst the two or more user devices on the at least one wireless network.
